(19) United States
(12) Patent Application Publication
(10) Pub. No.: US 2015/0190919 A1
(43) Pub. Date: Jul. 9, 2015

(54) TOOL BOX

(71) Applicant: Yuu Ching Plastics Corp., Taichung City (TW)

(72) Inventor: Shu-Wei Chang, Taichung City (TW)

(73) Assignee: Yuu Ching Plastics Corp., Taichung City (TW)

(21) Appl. No.: 14/146,876

(22) Filed: Jan. 3, 2014

(51) Int. Cl. B25H 3/02; A44B 11/28

(52) U.S. Cl. CPC B25H 3/02; A44B 11/28

(57) ABSTRACT

A tool box has a casing and a buckle module. The casing has two bodies connected with each other. The buckle module is mounted on the bodies and has a buckle base mounted on one of the bodies, a fastening base mounted on the other body, a fastening unit, a torsion spring and an abutting unit. The fastening base has an engagement portion. The fastening unit is pivotally mounted on the buckle base and has a hook portion hooked on the engagement portion. The torsion spring recess is formed on the fastening unit. The mounting pin protrudes out from the fastening unit. The torsion spring is mounted around the mounting pin and abuts the torsion spring recess. The abutting unit is mounted on the buckle base and abuts the torsion spring.

### BACKGROUND OF THE INVENTION

1. Field of the Invention

The present invention relates to a tool box, and more particularly to a tool box that has a self fastening capability.

2. Description of Related Art

A conventional tool box has two bodies and two buckle units. The bodies are connected with each other and can be opened or closed relative to each other. The buckle units are respectively mounted on the bodies. When the bodies are closed, the buckle units are engaged with each other to keep the bodies from detaching from each other.

However, to close the conventional tool box, a user has to first align the buckle units with each other to make the buckle units engaged with each other. The buckle units cannot be self-buckled. Therefore, it is inconvenient for a user to use the tool box.

### SUMMARY OF THE INVENTION

The main objective of the present invention is to provide a tool box to resolve the aforementioned problem.

The tool box has a casing and a buckle module.

The casing has two bodies connected with each other, and each body has a pivoting side and a connecting side opposite to the pivoting side, wherein the bodies are connected with each other at the pivoting sides.

The buckle module is mounted on the connecting sides of the bodies and has a buckle base, a fastening base, a fastening unit, a torsion spring and an abutting unit. The buckle base is mounted on one of the bodies. The fastening base is mounted on the other body opposite to the buckle base, selectively abuts the buckle base, and has an engagement portion. The fastening unit is pivotally mounted on the buckle base and has a hook portion selectively hooked on the engagement portion, a torsion spring recess formed on a side of the fastening unit, and a mounting pin protruding out from the fastening unit. The torsion spring is mounted around the mounting pin and has two ends, wherein one of the ends is mounted in the torsion spring recess. The abutting unit is mounted on the buckle base and abuts the other end of the torsion spring that is opposite to the torsion spring recess.

Other objectives, advantages and novel features of the present invention will become more apparent from the following detailed description when taken in conjunction with the accompanying drawings.

### BRIEF DESCRIPTION OF THE DRAWINGS

FIGS. 1A to 1B are perspective views of a preferred embodiment of a tool box in accordance with the present invention;

FIG. 2 is a partially enlarged exploded perspective view of the tool box in FIG. 1;

FIG. 3 is a partially exploded perspective view of the tool box in FIG. 1;

FIG. 4 is a cross sectional side view along line 4-4 in FIG. 1;

FIG. 5 is a cross sectional side view along line 5-5 in FIG. 1;

FIG. 6 is a partially rear view of the tool box in FIG. 1;

FIGS. 7A to 7B are operational cross sectional side views of the tool box in FIG. 1; and

FIGS. 8A to 8C are operational cross sectional side views of the tool box in FIG. 1.

### DETAILED DESCRIPTION OF PREFERRED EMBODIMENT

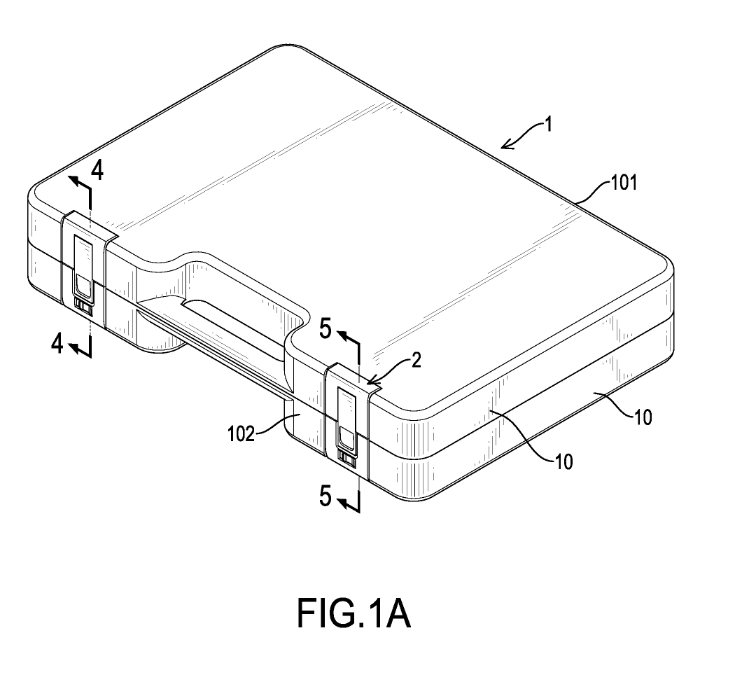

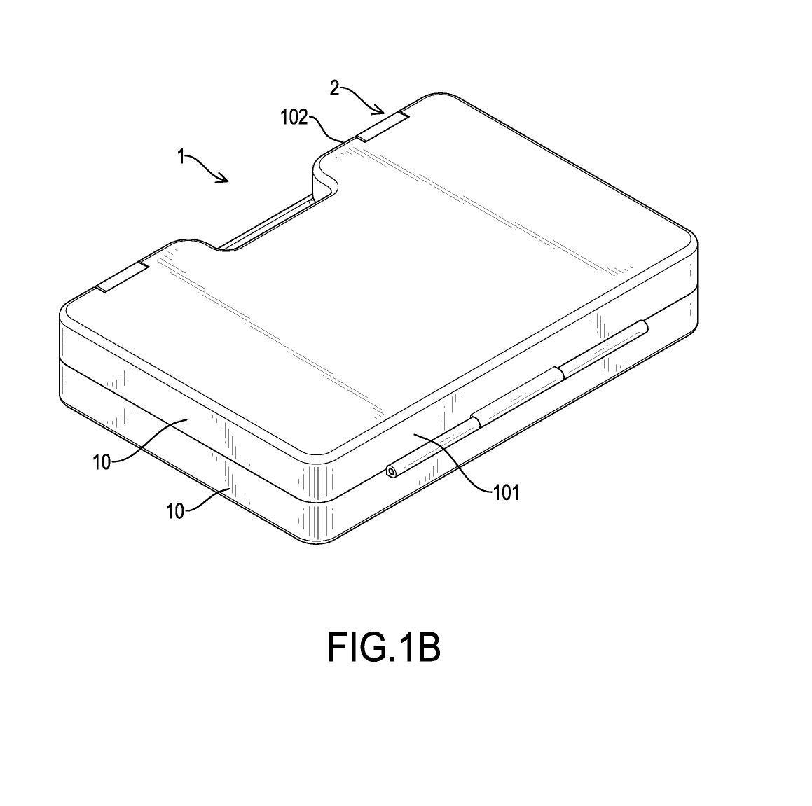

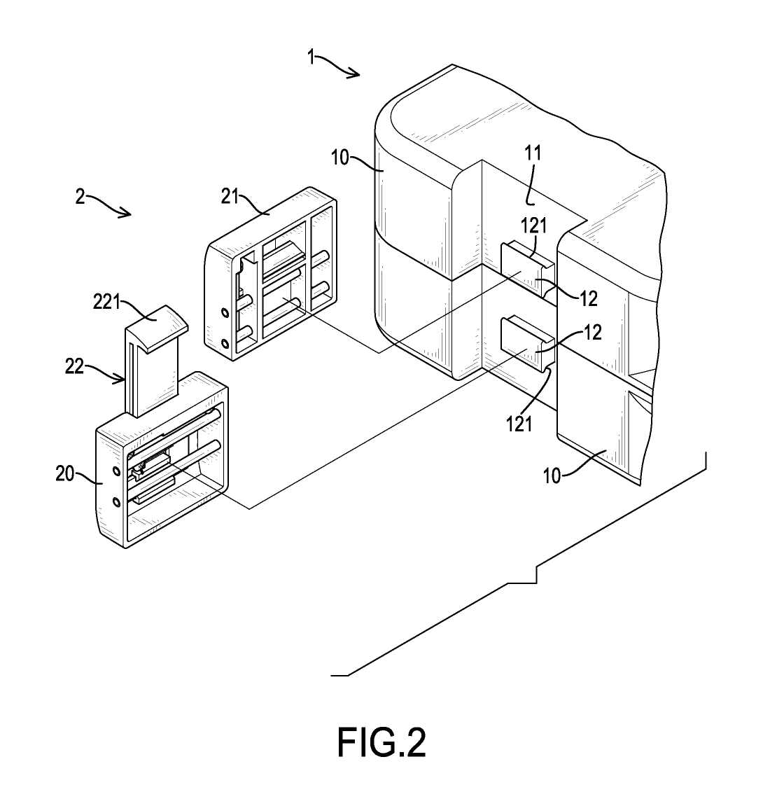

With reference to FIGS. 1A, 1B, and 2, a preferred embodiment of a tool box in accordance with the present invention has a casing 1 and two buckle modules 2.

The casing 1 has two bodies 10, two mounting troughs 11 and two pairs of mounting blocks 12. Each body 10 has a pivoting side 101 and a connecting side 102 opposite to the pivoting side 101. The bodies 10 are connected with each other at the pivoting sides 101 and can be opened or closed relative to each other. The mounting troughs 11 are formed on the connecting sides 102 of the bodies 10 at an interval. The two pairs of mounting blocks 12 are respectively formed in the mounting troughs 11, wherein two mounting blocks 12 of each pair of mounting blocks 12 are respectively formed in the bodies 10. Each mounting block 12 has two elongated recesses 121. The recesses 121 are respectively formed in two opposite sides of the mounting block 12.

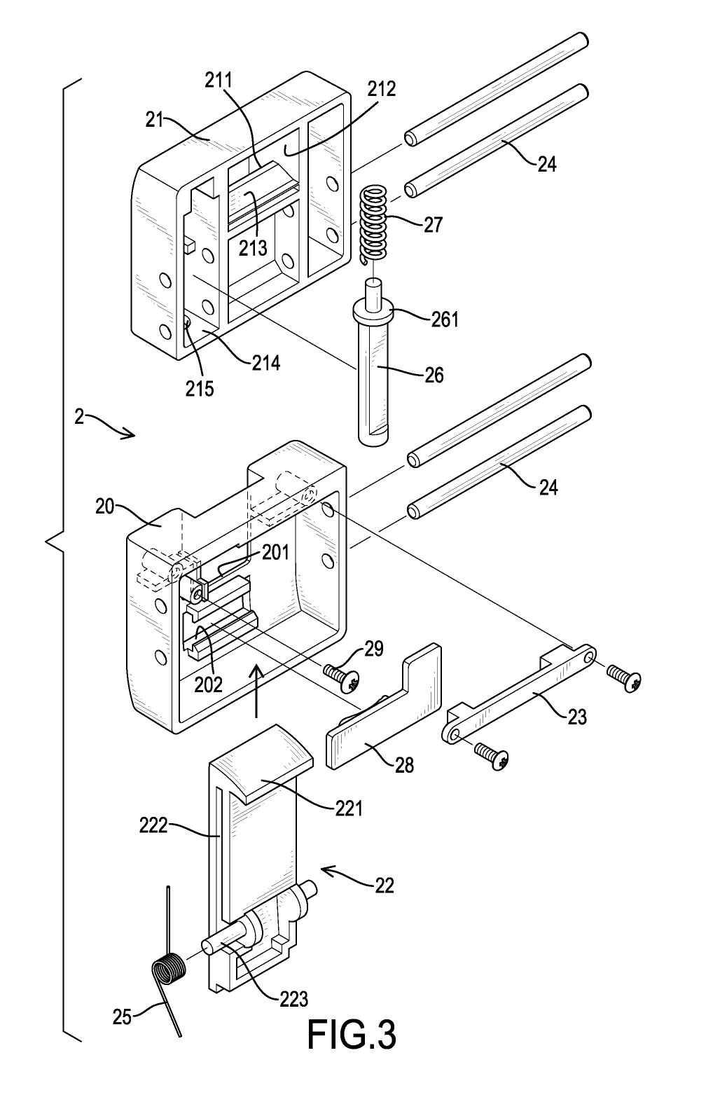

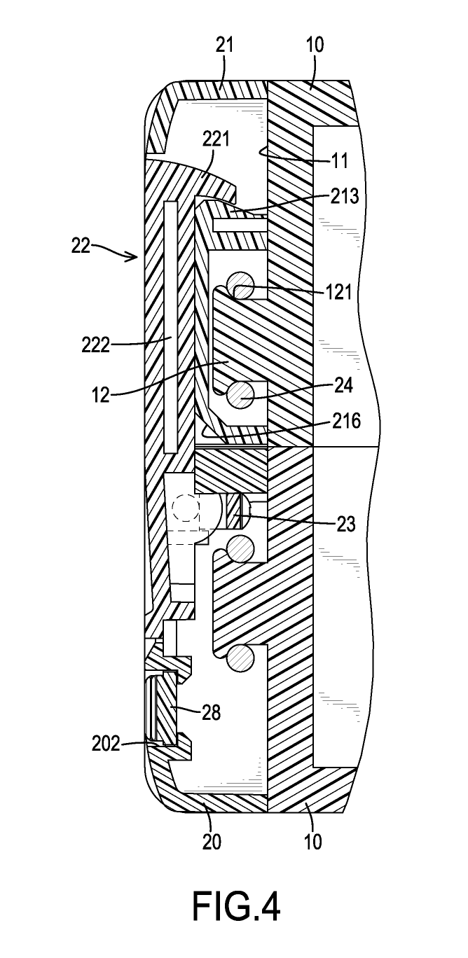

With reference to FIGS. 3 and 4, the buckle modules 2 are respectively mounted in the mounting troughs 11. Each buckle module 2 has a buckle base 20, a fastening base 21, a fastening unit 22, a fixing unit 23, two pairs of fixing pins 24, a torsion spring 25, a protruding unit 26, a spring 27, a locking unit 28 and an abutting unit 29.

The buckle base 20 is mounted in a corresponding one of the mounting troughs 11 and has a fastening unit opening 201 and a locking unit opening 202. The fastening unit opening 201 and the locking unit opening 202 are formed through the buckle base 20 at an interval.

The fastening base 21 is mounted in a corresponding one of the mounting troughs 11 and has a fastening unit trough 211, an engagement opening 212, an engagement portion 213, a protruding unit trough 214, a protruding unit opening 215 and a pushing surface 216. The fastening unit trough 211 is formed on the fastening base 21 at a position opposite to the casing 1 and communicates with the fastening unit opening 201. The engagement opening 212 is formed through the fastening base 21 and communicates with the fastening unit trough 211. The engagement portion 213 is formed on the fastening base 21 and is adjacent to the engagement opening 212. The engagement portion 213 is tapered and a side of the engagement portion 213 adjacent to the engagement opening 212 is inclined. The protruding unit trough 214 is elongated, is formed in the fastening base 21 and faces the mounting trough 11. The protruding unit opening 215 is formed through the fastening base 21 along a longitudinal direction of the protruding unit trough 214 and communicates with the protruding unit trough 214. The pushing surface 216 is inclined, is formed on a side of the fastening unit trough 211 and is adjacent to the buckle base 20.

With reference to FIGS. 1, 3 and 4, the fastening unit 22 is mounted in the fastening unit opening 201 and the fastening unit trough 211, is pivotally mounted on the buckle base 20 and has a hook portion 221, a torsion spring recess 222 and a mounting pin 223. The hook portion 221 is formed on an end of the fastening unit 22 and is selectively hooked on the engagement portion 213. The torsion spring recess 222 is formed on a side of the fastening unit 22. The mounting pin 223 protrudes out from the fastening unit 22 and is adjacent to the torsion spring recess 222.

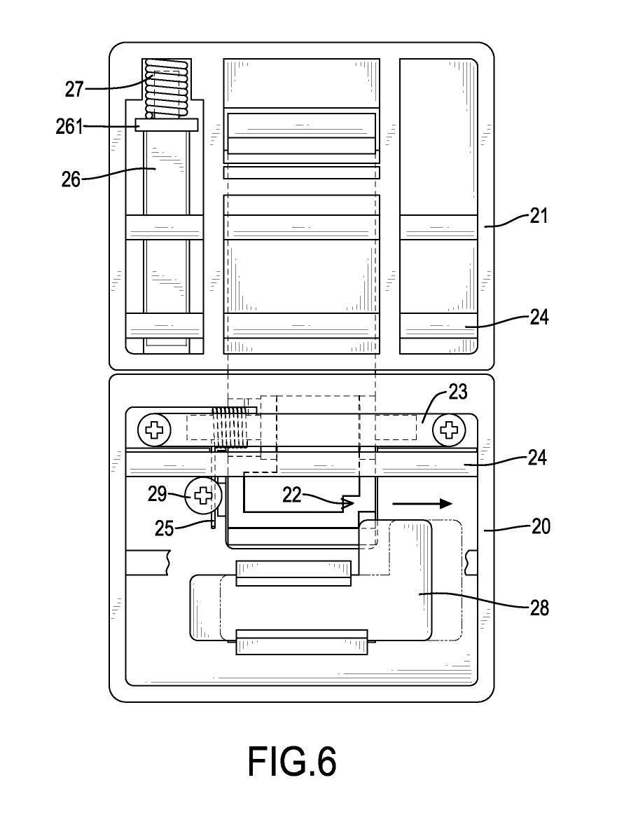

With reference to FIGS. 1, 3, 5 and 6, the fixing unit 23 is mounted on the buckle base 20 and abuts the fastening unit 22 to position the fastening unit 22, such that the fastening unit 22 is kept from detaching from the buckle base 20. The two pairs of fixing pins 24 are respectively mounted on the buckle base 20 and the fastening base 21, wherein the two pairs of fixing pins 24 are respectively mounted in the elongated recesses 121 of the mounting blocks 12 to fix the buckle base 20 and the fastening base 21 on the bodies 10. The torsion spring 25 is mounted around the mounting pin 223. One of two ends of the torsion spring 25 is mounted in the torsion spring recess 222. The protruding unit 26 is mounted in the protruding unit trough 214, selectively protrudes out of the protruding unit opening 215 and has an abutting plate 261 annularly formed on the protruding unit 26. The spring 27 is mounted around the protruding unit 26 and abuts between the abutting plate 261 and the fastening base 21. The locking unit 28 is slidably mounted on the buckle base 20 and is exposed from the locking unit opening 202. The locking unit 28 selectively abuts the fastening unit 22. When the locking unit 28 abuts the fastening unit 22, the fastening unit 22 is locked and cannot be pressed. The abutting unit 29 is mounted on the buckle base 20 and abuts one of the ends of the torsion spring 25 at a position opposite to the torsion spring recess 222.

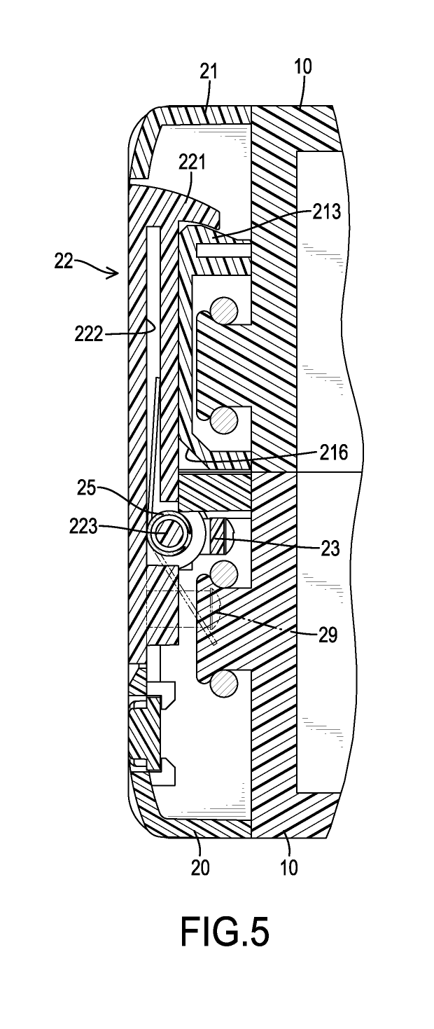

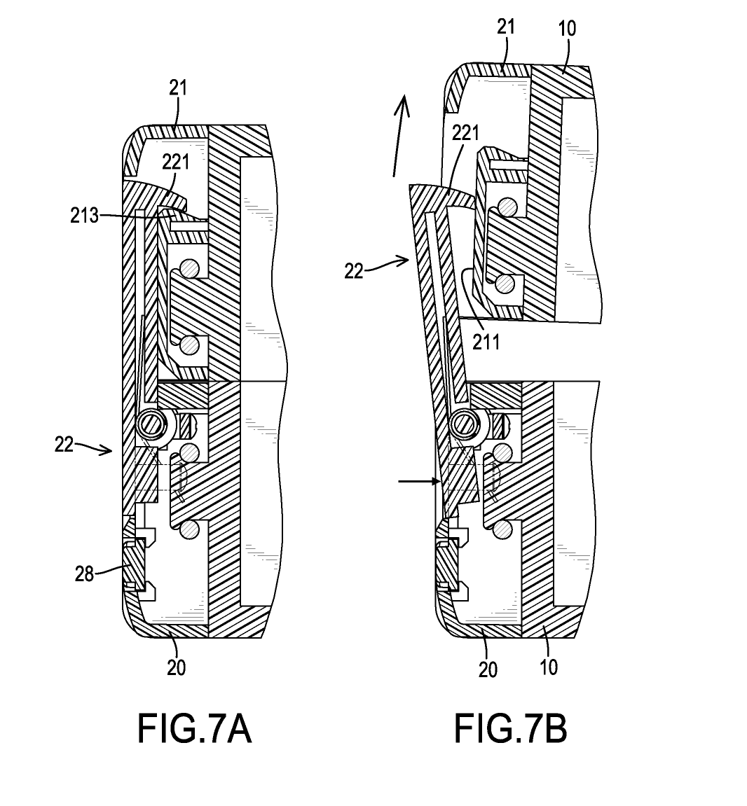

With reference to FIGS. 5, 7A to 7B, in use, the locking unit 28 is slid away from abutting the fastening unit 22, such that the fastening unit 22 can be pressed. When the fastening unit 22 is pressed, the hook portion 221 is detached from the engagement portion 213, such that the fastening relationship between the buckle base 20 and the fastening base 21 is released. The protruding unit 26 protrudes from the protruding unit opening 215 to push the buckle base 20 by an elastic force of the spring 27, such that an interval is formed between the buckle base 20 and the fastening base 21. A user can open the bodies 10 easily from the interval between the buckle base 20 and the fastening base 21. When the fastening base 21 is detached from the buckle base 20, the fastening unit 22 is inclined relative to the buckle base 20, and the hook portion 221 of the fastening unit 22 abuts the fastening unit trough 211. When the bodies 10 are detached from each other by the user, the fastening unit 22 is reset to the original position relative to the buckle base 20 by an elastic force of the torsion spring 25.

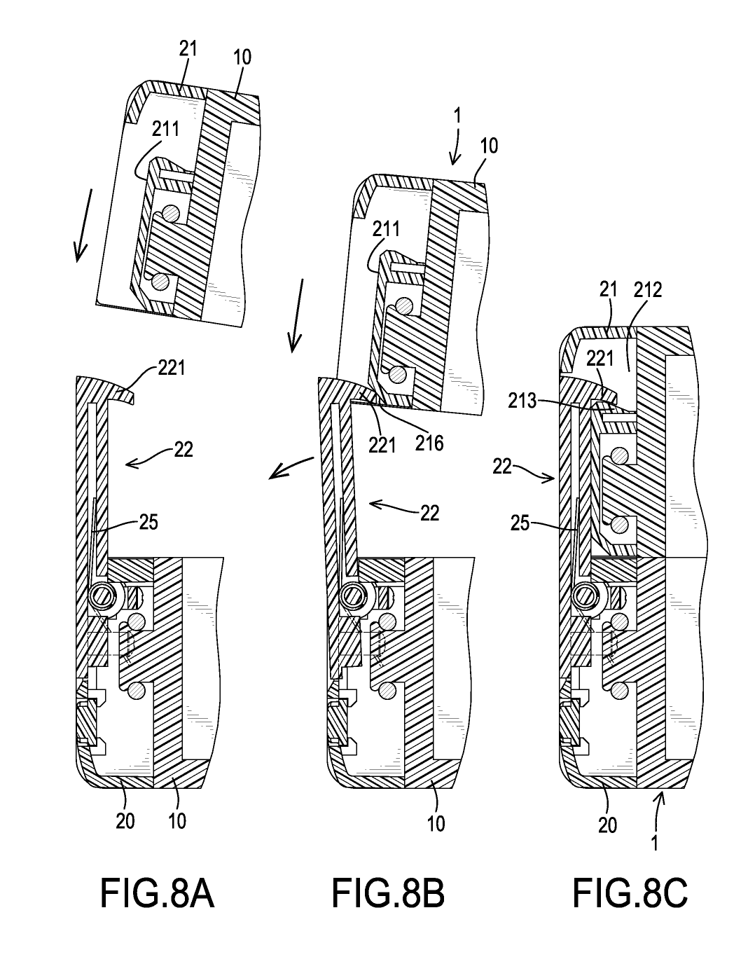

With reference to FIGS. 5, 8A to 8C, when the bodies 10 are to be fastened with each other again, the fastening base 21 can be moved to approach the buckle base 20. Then, the pushing surface 216 abuts and pushes the hook portion 221, such that the fastening unit 22 can be pivoted relative to the buckle base 20 and abuts the fastening unit trough 211 again. When the hook portion 221 is detached from the fastening unit trough 211 and is inserted into the engagement opening 212, the torsion spring 25 forces the fastening unit 22 to hook the engagement portion 213 again. Therefore, the bodies 10 are fastened with each other again.

From the above description, it is noted that the present invention has the following advantages:

1. When the fastening base 21 approaches the buckle base 20 and the hook portion 221 corresponds to the engagement portion 213 in position, the torsion spring 25 forces the fastening unit 22 to hook the engagement portion 213 automatically. Therefore, the casing 1 can be closed smoothly.

2. When the fastening base 21 approaches the buckle base 20, the pushing surface 216 can push the fastening unit 22 outward. When the fastening unit 22 is pressed, the protruding unit 26 can protrude from the protruding unit opening 215 to form the interval between the buckle base 20 and the fastening base 21, such that the bodies 10 can be detached from each other automatically. The locking unit 28 can be slid relative to the buckle base 20 to selectively abut the fastening unit 22. When the locking unit 28 abuts the fastening unit 22, the fastening unit 22 can be ensured not to be pressed.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tool box having:
a casing having two bodies connected with each other, and each body has a pivoting side and a connecting side opposite to the pivoting side, wherein the bodies are connected with each other at the pivoting sides; and
a buckle module mounted on the connecting sides of the bodies and having
a buckle base mounted on one of the bodies;
a fastening base mounted on the other body opposite to the buckle base, selectively abutting the buckle base, and having an engagement portion;
a fastening unit pivotally mounted on the buckle base and having
a hook portion selectively hooked on the engagement portion;
a torsion spring recess formed on a side of the fastening unit; and
a mounting pin protruding out from the fastening unit;
a torsion spring mounted around the mounting pin and having two ends, wherein one of the ends is mounted in the torsion spring recess; and
an abutting unit mounted on the buckle base and abutting the other end of the torsion spring that is opposite to the torsion spring recess.

2. The tool box as claimed in claim 1, wherein the fastening base further has
a fastening unit trough formed in the fastening base at a position opposite to the casing, connected with the engagement portion and selectively abutting the hook portion;
an engagement opening formed through the fastening base, communicating with the fastening unit trough and being adjacent to the engagement portion; and
a pushing surface being inclined, formed on a side of the fastening unit trough, being adjacent to the buckle base and selectively abutting the hook portion.

3. The tool box as claimed in claim 2, wherein
the buckle module further has two pairs of fixing pins respectively mounted on the buckle base and the fastening base;
each body further has a mounting block formed on the body, wherein each mounting block has two recesses being elongated and respectively formed in two opposite sides of the mounting block, wherein the two pairs of fixing pins are respectively mounted in the recesses of the mounting blocks to fix the buckle base and the fastening base on the bodies.

4. The tool box as claimed in claim 3, wherein the buckle module further has a fixing unit mounted on the buckle base and abutting the fastening unit.

5. The tool box as claimed in claim 4, wherein the buckle module further has
a protruding unit mounted on the fastening base and selectively protruding out of the fastening base; and
a spring mounted around the protruding unit and abutting between the protruding unit and the fastening base.

6. The tool box as claimed in claim 1, wherein
the buckle base further has a locking unit opening formed through the buckle base; and
the buckle module further has a locking unit slidably engaged with the buckle base, exposed from the locking unit opening, and selectively abutting the fastening unit.

7. The tool box as claimed in claim 2, wherein
the buckle base further has a locking unit opening formed through the buckle base; and
the buckle module further has a locking unit slidably engaged with the buckle base, exposed from the locking unit opening, and selectively abutting the fastening unit.

8. The tool box as claimed in claim 3, wherein
the buckle base further has a locking unit opening formed through the buckle base; and
the buckle module further has a locking unit slidably engaged with the buckle base, exposed from the locking unit opening, and selectively abutting the fastening unit.

9. The tool box as claimed in claim 4, wherein
the buckle base further has a locking unit opening formed through the buckle base; and
the buckle module further has a locking unit slidably engaged with the buckle base, exposed from the locking unit opening, and selectively abutting the fastening unit.

10. The tool box as claimed in claim 5, wherein
the buckle base further has a locking unit opening formed through the buckle base; and
the buckle module further has a locking unit slidably engaged with the buckle base, exposed from the locking unit opening, and selectively abutting the fastening unit.
